(19) United States
(12) Patent Application Publication
(10) Pub. No.: US 2001/0025874 A1
(43) Pub. Date: Oct. 4, 2001

(54) Method of forming solder bumps, method of mounting flip chips, and a mounting structure

(75) Inventor: Tomohiro Nishiyama, Tokyo (JP)

Correspondence Address: Norman P. Soloway, Esq., HAYES, SOLOWAY, HENNESSEY,, GROSSMAN & HAGE, P.C., 175 Canal Street, Manchester, NH, 03101, US

(73) Assignee: NEC Corporation

(21) Appl. No.: 09/819,518

(22) Filed: Mar. 27, 2001

(30) Foreign Application Priority Data
Mar. 28, 2000 (JP) 092937/2000

(51) Int. Cl. B23K 31/02; B23K 1/20; B23K 35/12

(52) U.S. Cl. 228/180.22; 228/223; 228/246

(57) ABSTRACT

Solder balls are mounted on electrodes with an active resin therebetween. The solder is heated and melts to be connected to pads of an LSI chip, thereby forming solder bumps on the chip. In a method of forming bumps, a method of mounting flip chips, and a mounting structure, by the use of the active resin, a flux washing process can be eliminated and at the same time, an assembly cost can be minimized.

### BACKGROUND OF THE INVENTION

The present invention relates to a method of forming solder bumps using a thermosetting resin having the effect of flux (hereinafter referred to as an active resin), to a method of mounting flip chips using solder bumps, and to a mounting structure obtained by using these methods.

The known bump forming methods include a ball mounting method, a solder-paste printing method, a method using plating or coating, a method using evaporation, and the like. In the ball mounting method, solder balls are arranged on a suction head and a flux is fixed on tips or end portions of the balls, or on a connecting surface of a large-scale integration (LSI) chip. The solder balls are mounted on electrodes of the LSI chip with the help of adhesive of the flux. The chip is then subjected to a reflow process to form solder bumps.

The solder-paste printing method carries out a reflow process by using a flux contained in the paste so as to form solder bumps. In the method using plating or evaporation, the plating or evaporation process is conducted to form a solder film or coat. After applying a flux to the solder film, a reflow process is carried out to form bumps with a spherical surface. In either case, a flux is employed to form bumps, which consequently requires a washing process to remove the flux. This causes cost problems concerned with, for example, man hour required for the washing process, equipment investment, and the like.

The flux also causes problems. That is, after carrying out a reflow process, if the washing is insufficient, an active agent remains on electronic components such as an LSI chip. If the residuary active agent absorbs moisture, ions thereof deteriorate electrical insulating, thus decreasing reliability of produced electronic components by, for example, migration and the like.

FIGS. 10A to 10E show a known method of mounting flip chips. As shown in FIG. 10A, balls 3 held by a ball mounter head 4 are mounted on an LSI chip 5 to which a flux 12a is applied. FIG. 10B shows the LSI chip 5 with bumps 3 thereupon formed through a reflow process. The LSI chip 5 with bumps 3 is loaded on a mounter head 7 and aligned against a printed wiring board 8 as shown in FIG. 10C. In this process, a flux 12b is applied to the board 8. FIG. 10D illustrates that the board 8 with the chip 5 thereupon is subjected to a reflow process, and then the flux 12b is removed by washing it. Finally, as shown in FIG. 10E, a process of filling an underfill is carried out.

In the method of mounting flip chips, a flux is applied to tips of the bumps or to the printed wiring board, before mounting an LSI chip. Thereafter, a soldering is achieved for making soldered joint. This method has a similar problem as the way for forming bumps.

Particularly, as pin spacing of LSI chips becomes finer due to increase in the degree of circuit integration, the height of bumps inclines to become lower and the gap between the LSI chip and the board becomes narrower. This makes it more difficult to remove a flux by the washing compared with the prior art method. The residuary flux therefore becomes a serious problem. Such flux leads to the above-mentioned problem of a lower reliability and to inhibition of the process of filling an underfill. This results in lowering a yield rate of the assembly or fabricated products such as LSI chips.

To overcome this difficulty, there has been proposed, as shown in FIG. 9, a method of mounting a flip chip where a thermosetting resin 1 having the effect of flux is employed, without using an ordinary flux.

However, when the above-mentioned method is applied to an LSI chip having a large number of bumps, air is easily swallowed up in a region surrounded by the bumps. Consequently, the air rapidly expands due to a high temperature associated with a reflow process, thus causing cracks on the chip. Furthermore, if quantity of the resin is not properly controlled when conducting a reflow process, there arises a problem in the mounting process that the LSI chip is shifted from its appropriate position by ascending force of the resin. Moreover, the resin should meet the following requirements. The resin should have resistance to moisture absorption to prevent water contained in the resin from expanding explosively by a rapid heating applied to the resin in a reflow process and giving rise to cracks and the like. Selection should be made that the resin has a small thermal-expansion coefficient similar to that of a silicon substrate or the like to alleviate a thermal stress. As far as properties are concerned, it is not easy for the resin to be compatible with a flux.

In a flip-chip ball grid array (FCBGA), an LSI chip is mounted on a circuit board over solder bumps and for that purpose a flux is used to establish connections in many situations. For example, a flux is used in cases where solder bumps are formed by mounting balls on an LSI chip, where the LSI chip with the bumps thereupon is put on an inter pouser board, where the LSI chip is mounted on the inter pouser board with the help of the bumps, and where the inter pouser board with the LSI chip thereupon is mounted on a printed wiring board. When a solder consisting of Sn (stannum)/Pb (lead) and with a high melting point is used as a solder material in the processes mentioned above, the flux burnt in due to a high temperature provided in a reflow process cannot be completely washed out. This may cause defects after the flip chip is mounted. For example, the underfill resin peels off from the board or chip. In the flip-chip mounting, a special washing apparatus is employed to wash out foreign matters in a small gap. However, even with the special washing apparatus, the method requires a long period of time for the washing, thus raising cost problems. It is estimated that further finer spacing is required in the future LSI chips, the present washing method has therefore difficulties in achieving reliability even when the above-mentioned washing apparatus is employed.

For this reason, it is necessary to develop the way requiring no washing processes by making it fluxless, as quickly as possible. It should be noted that a process has been proposed in which an active resin is dropped before conducting a flip-chip mounting. This process simplifies the process itself. However, it has not yet led to ensure that characteristics of the hardened resin satisfy electrical reliability of the devices.

### SUMMARY OF THE INVENTION

It is therefore an object of the present invention to provide a method of forming solder bumps, comprising the steps of mounting a solder on electrodes of an LSI chip over an active resin; and applying a heat to melt said solder, so as to form solder bumps, whereby said solder bumps are connected to said electrodes.

In the heat applying step according to the present invention, the solder having a predetermined shape and the electrodes are connected by substantially removing the active resin at least in the boundaries between the solder and electrodes.

According to the present invention, the active resin is a heat-curable resin that is cured when the heat is applied.

According to another invention, a method of mounting flip chips is provided, the method comprising the steps of: applying an active resin on end portions of solder bumps of an LSI chip and/or at least on pads of a board on which bumps are to be formed; mounting said LSI chip on said board by fitting position of said chip; applying a heat to melt said solder bumps, so that said solder bumps are being connected to said board; and filling an underfill resin in a gap between said LSI chip and said board.

In the above invention, the active resin is a thermosetting resin having the effect of flux.

According to still another invention, there is provided a method of mounting flip chips comprising the steps of applying a first active resin to a solder with a predetermined shape and/or at least to pads of an LSI chip on which bumps are to be formed; mounting said solder on said LSI chip so that said chip is subjected to a reflow process to form solder bumps thereupon; applying a second active resin to end portions of said solder bumps and/or at least to pads of a board on which bumps are to be formed; mounting said LSI chip on said board by fitting position of said chip; applying a heat to melt said solder bumps, so that said solder bumps are being connected to said board; and filling an underfill resin in a gap between said LSI chip and said board.

According to still another invention, there is provided a mounting structure comprising: an LSI chip that is subjected to a flip-chip mounting by using solder bumps, characterized in that said LSI chip uses an active resin at least in connecting portions of said solder bumps and in its vicinity.

According to another invention, there is provided a mounting structure comprising: an LSI chip having solder bumps thereupon, characterized in that a protective film composed of a cured active resin is formed on a surface of said LSI chip.

According to another invention, a mounting structure is provided which comprising: an LSI package to which solder balls are connected; characterized in that connecting portions of said solder balls and in its vicinity associated with pads for external terminals of said LSI package have a resin for reinforcement composed of at least a cured active resin.

According to another invention, a mounting structure is provided, comprising: an LSI chip and a board connected each other via solder bumps; characterized in that a thermosetting resin having the effect of flux is cured on overall surface of said board or on portions connecting said board and said solder bumps, and in that an underfill resin is filled in a gap between said LSI chip and said board.

According to still another invention, there is provided a mounting structure comprising: an LSI chip and a board connected each other via solder bumps; characterized in that a thermosetting resin is cured on overall surface of said LSI chip or on portions connecting said said LSI chip and said solder bumps, and on overall surface of said board or on portions connecting said board and said solder bumps, and in that an underfill resin is filled in a gap between said LSI chip and said board.

### BRIEF DESCRIPTION OF THE DRAWINGS

The objects and features of the present invention will become more apparent from the consideration of the following detailed description taken in conjunction with the accompanying drawings in which:

FIG. 1 is a diagram showing an example in which solder balls are held by suction of a mounter head;

FIG. 2 is a diagram showing an example where solder balls with a fixed active resin are aligned against electrodes on an LSI chip;

FIG. 3 shows an LSI chip on which solder bumps are formed by conducting a reflow process;

FIG. 4 is a diagram showing an operation to mount an LSI chip on a printed wiring board, where the chip has bumps formed thereupon and held by suction of a mounter head, and where an active resin is fixed onto a surface of the bumps;

FIG. 5 shows an LSI chip with bumps formed thereupon is connected to a printed wiring board on which copper pads are arranged, after the chip and board have been subjected to a reflow process;

FIG. 6 is a diagram showing an operation to fill an underfill resin by a dispenser or the like in a gap between an LSI chip and a plate;

FIG. 7 shows an example of a flip chip on which a thermosetting resin having the effect of flux is employed as a protective film;

FIG. 8 is an LSI chip and a board between which an active resin is used as an underfill resin.

FIG. 9 is a diagram showing a prior art example in which a thermosetting resin having the effect of flux is applied to a flip-chip mounting operation; and

FIGS. 10A to 10E show a known method of mounting flip chips associated with a prior art technique.

### DESCRIPTION OF THE EMBODIMENTS

The present invention relates to a method of forming solder bumps using a thermosetting resin having the effect of flux, to a method of mounting flip chips using solder bumps, and to a mounting structure obtained by using these methods, that is, the methods of forming solder bumps and of mounting flip chips. More specifically, the present invention provides a soldering process for making soldered connections, which employs an active resin in place of a flux used in the prior art bump forming process and flip-chip mounting process.

In the bump forming process according to the present invention, solder bumps are formed on pads with the help of the active resin having the effect of flux, which are then subjected to a flip-chip mounting without removing the active resin. Therefore, a washing process required in the prior art process can be omitted and the process itself becomes simple. Moreover, this prevents reliability from being influenced by the residuary flux due to insufficient washing. Additionally, hardened or cured active resin plays a role to strengthen the bumps and hence protect the chip.

When conducting the flip-chip mounting, an LSI chip is connected to a board by using the active resin, and an underfill resin is filled in a gap between the chip and board without removing the active resin. The process can therefore be simplified and at the same time, a mounting structure can be prevented from being adversely affected by the residuary flux. As for an underfill resin, it is also possible to adopt a resin having high reliability and satisfactory characteristics in the filling operation. Consequently, the mounting structure with high reliability can be produced. Unless otherwise explicitly described, as a concept of mounting structure, the mounting structure according to the present invention includes, for example, a structure coated with an active resin before it is hardened.

Primary action of a flux in an ordinary soldering process resides in chemical actions which remove an oxide film formed on a surface of the solder and that on a connection area to be connected by the solder. The flux also covers the solder and the pertinent surface to prevent oxidization thereof. Known resins used as a flux for soldering include a rosin, a rosin-denatured resin, and a synthetic resin. However, the flux using these resins lacks a thermosetting property, and has neither effect to strengthen bumps nor effect to alleviate thermal stress in a flip-chip mounting structure. As an activator contained in the flux, there has been used an amine-based halogen salt, an organic acid, or the like. However, if such activator remains even after the flux including the activator is washed out, the activator is ionized by moisture absorption, or the like. This deteriorates electrical insulation and hence causes migration.

On the other hand, an active resin (a thermosetting resin having the effect of flux) is composed of a thermosetting resin as a base material to which an agent having the effect of flux is added. Consequently, the active resin acts to remove an oxide film formed on a surface of the solder and a film on a connection area to be connected by the solder.

In other words, in a heating process of soldering before the resin is hardened, the agent having the effect of flux takes action, thereby removing an oxide film on a surface of the solder and that on a connection area to be connected by the solder. After the oxide film being removed, the surface is coated with the active resin. This advantageously prevents re-oxidation of the surface. The active resin when it is hardened links or bonds to a base resin, that is, it is tightly fixed onto the base resin to become chemically stable, and therefore provides a sufficient electrical insulation. The active resin includes a chemical compound consisting of an agent with a setting property to which a chemical group having the effect of flux is added. Resins having such property are included in the active resin employed in the present invention. Thermosetting resins include an epoxy, a polyester such as an unsaturated polyester, combinations of an unsaturated polyester and a compound having an active hydroxyl group, or the like, acrylate including a silicon acrylate and an epoxy acrylate of (metha)acryoxypropyl polysiloxane and the like. The resin has accelerator to act upon the thermosetting resin to accelerate hardening thereof in a thermosetting stage and/or a hardening agent (a radical initiator to generate radicals for hardening by heating, an anionic initiator or cationic initiator). It is also possible to use adhesive such as α-cyanoacrylate which hardens at room temperature. Two or more of the thermosetting resin, accelerator, hardener, and initiator mentioned above may be utilized in combination.

Agents having the effect of flux include an unsaturated acid such as a (metha)acrylic acid and a maleic acid, an organic diacid such as an oxalic acid and a malonic acid, and an organic acid such as a citric acid, and furthermore have at least one or more of a halogen group, a hydroxyl group, a nitrile group, a benzylic group, a carboxyl group, etc. to the side chain of hydrocarbon. By using the agents having the effect of flux, oxide films can be removed. Agents having the effect of flux also include an unsaturated alcohol such as a (metha)allylic alcohol. Trimellitic acid, tetramellitic acid, and a well-known chelating agent may also be used as an agent with such effect. Two or more kinds of such agents having the effect of flux can be used in combination. Flux may include a known gelling agent.

Description will now be given in detail of a bump forming method, a method of mounting flip chips and the like, according to embodiments of the present invention. It should be noted that the present invention is not limited by the embodiments.

First Embodiment:

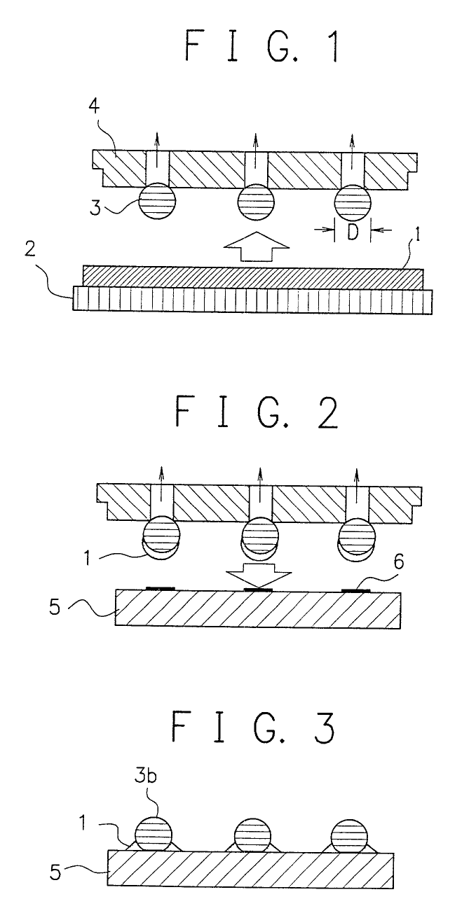

Referring to FIGS. 1 to 3, description will be given of a first embodiment according to the present invention, where solder bumps are formed by mounting solder balls on an LSI chip.

As can be seen from FIG. 1, solder balls 3 each having a diameter D of, for example, 0.15 millimeters (mm) are arranged beneath suction holes of a ball mounter head 4 in the same position patterns as those of electrodes arranged on an LSI chip (which will be described below). In the present embodiment, the solder balls are made of an Sn/Pb eutectic.

In the next process, an active resin 1 is applied to a flat plate 2 by using a screen printing method, and then the plate 2 is pressed with a predetermined load toward the solder balls 3 aligned as mentioned above. As a result, the active resin 1 is fixed onto surface of the balls 3 as shown in FIG. 1. The active resin 1 printed on the plate 2 has a thickness of 0.04 (mm).

The solder balls 3 according to the present embodiment are made of, for example, an Sn/Pb eutectic. However, material of the bumps is not limited to an Sn/Pb eutectic. For example, Sn/Pb (excluding an Sn/Pn eutectic), Sn/Ag, Sn/Cu, Sn/Sb, Sn/Zn, Sn/Bi, and material produced by adding particular addition elements to any one of these materials are available and can be used accordingly.

With a coating method such as a screen printing process, the active resin may be applied to the overall surface of an LSI chip or to particular portions thereof, for example, areas associated with the pads. It is noted that the present invention is not limited by a coating method such as the screen printing process as mentioned above. There may be employed, for example, a coating method using a squeegee, a method of spin coating, and the like. Pin coating process in which only the solder balls can be coated with an active resin may also be used. Furthermore, there may be adopted a coating method where an active resin is made to have a gel state by including a gelling agent or the like, on a plate in a form of film, thereafter the active resin is transferred to the solder balls.

As shown in FIG. 2, electrodes 6 on an LSI chip 5 are aligned to the solder balls 3, the balls 3 are then pressed with a predetermined load toward the LSI chip 5. As a result, the balls 3 are temporarily fixed onto the LSI chip 5 due to adhesive of the active resin 1. In the present embodiment, the LSI chip 5 has copper pads arranged in a lattice with a spacing of 0.25 mm. However, the LSI pads are not limited to have a copper surface. For example, the pads may be formed by nickel (Ni) with a gold (Au) thin layer thereupon.

In the next process, the LSI chip 5 on which the balls 3 have been temporarily fixed is fed into a reflow furnace or chamber (not shown) where a heat is applied to the solder. The solder thereby melts to establish connections with the electrodes on the LSI chip 5 by appropriately using the effect of flux exhibited by the active resin 1. As a result of this process, solder bumps 3b are formed on the LSI chip 5 as shown in FIG. 3. The electrodes of the LSI are therefore electrically conductive to the balls 3. Substantially, there remains no hardened active resin in the boundaries between the LSI's electrodes and the bumps. Accordingly, there is no possibility of conduction defect.

Subsequent to the reflow process, the active resin is fully hardened in a curing (after-hardening) process if necessary. Therefore, the active resin chemically stable and hardened remains on the LSI chip. With completion of the hardening process, the agent having the effect of flux does not practically move in the active resin, and loses the effect of flux. Therefore, contrary to an ordinary flux used for soldering, no washing is required to remove the flux. The LSI chip obtained through the above-mentioned process can be provided for the post process, that is, a flip-chip mounting process.

In the present invention, if the active resin is applied, not to the areas in the vicinity of end portions of the ball, but to the overall of the ball, the active resin, after it is hardened or cured, may be removed by a mechanical grinding or the like. When the ball has a thin and hardened active resin on its end portions, the resin may be removed by a plasma cleaning, brushing, and the like.

The active resin used in the present invention can also provide a reinforcing effect as far as strength of bump connections is concerned. Additionally, when the active resin is applied to the overall surface by, for example, a printing process, the active resin can also serve as a resin for protection.

Second Embodiment:

Referring now to FIGS. 4 to 6, description will be given of a second embodiment according to the present invention. In the second embodiment, an LSI chip with arranged copper pads on which bumps have been formed is mounted on a printed wiring board which also has copper pads arranged in the same arrangement position as that of the LSI chip.

As shown in FIG. 4, the LSI chip 5 according to the second embodiment has bumps that have been formed by the method as described in the first embodiment. The LSI chip 5 is held beneath a mounter head 7 by a suction force of the mounter head 7, and an active resin 1b is then fixed onto a surface of the bumps in the same way as that described in the first embodiment. The bumps are aligned to electrodes 9 on a printed wiring board 8. The LSI chip 5 with the bumps is thereafter pressed with a predetermined load toward the board 8 so as to be temporarily fixed thereupon.

It is noted that an LSI chip with solder bumps made of an Sn/Pb eutectic can be utilized, where balls have been mounted by using an ordinary flux and then the flux has been washed out. It is also possible to pre-coat electrode pads on the board with an Sn/Pb eutectic solder or the like. The active resin may be applied to the overall surface of the printed wiring board 8 by using a screen printing method.

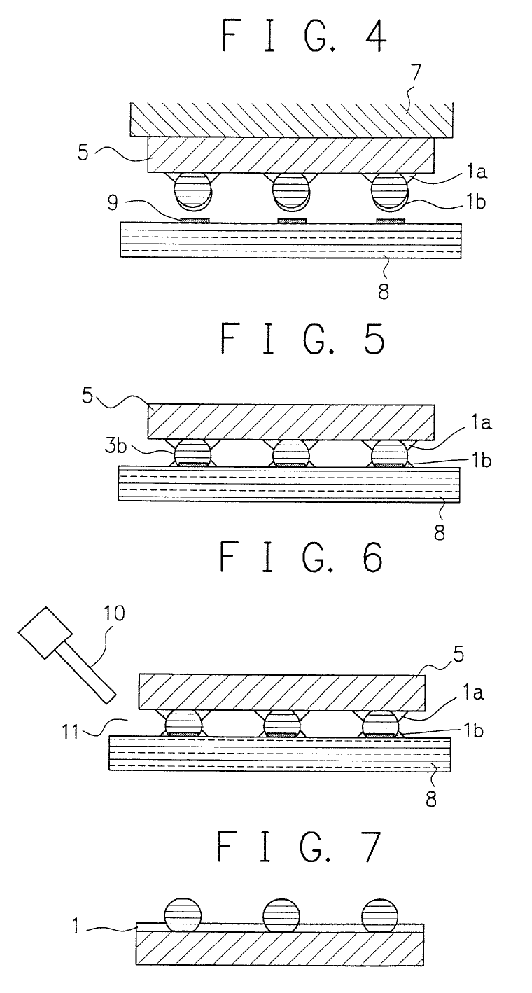

The board 8 on which LSI chip 5 has been temporarily fixed is fed into a reflow furnace or chamber (not shown) as shown in FIG. 5, where a heat is applied to melt the solder bumps 3b and a flip chip is resultantly connected to the board 8 by the effect of flux provided by the active resin 1b.

The active resin may be pre-cured for the purpose of providing a temporary fixing and carrying out a sufficient after-curing. The reflow process and mounting of an LSI chip may be simultaneously carried out by using a mounter capable of controlling the surface temperature of the mounter's head.

If the active resin is of a fast cure type, a process of filling an underfill can be immediately carried out. Alternatively, the active resin may be pre-cured to a state in which the active resin does not run off. Thereafter, the active resin 1b and the underfill resin 11 are simultaneously hardened as shown in FIG. 6.

In the present embodiment, the board 8 and LSI chip 5 once they are connected are subjected to supply of the underfill resin 11 without conducting a washing process. The board 8 on which the LSI chip 5 has been mounted is heated up to several tens of degrees (Celsius) by a hot plate, and thereafter the underfill resin 11 is supplied by a dispenser 10 from the sideward position of the LSI chip 5. In this operation, the underfill resin 11 is supplied by spreading it through the gap between the board and the chip by employing a capillary phenomenon. In the present invention, the active resin 11 is filled in the gap by the use of a capillary phenomenon, therefore there is no possibility of occurrence of voids which will be produced by air introduced into the resin 11.

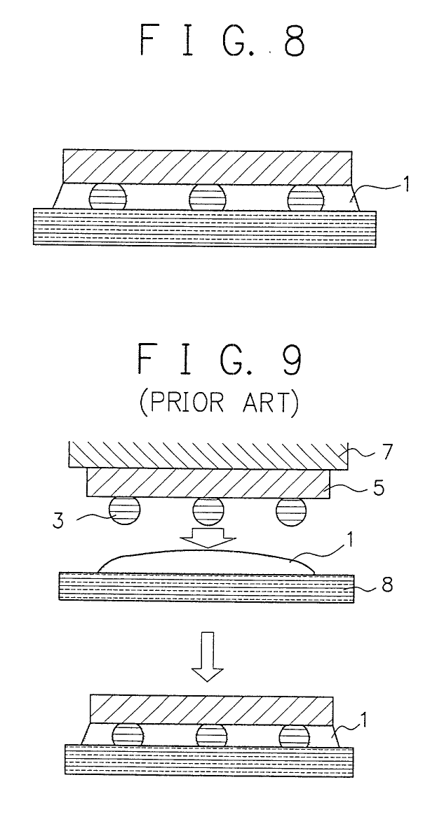

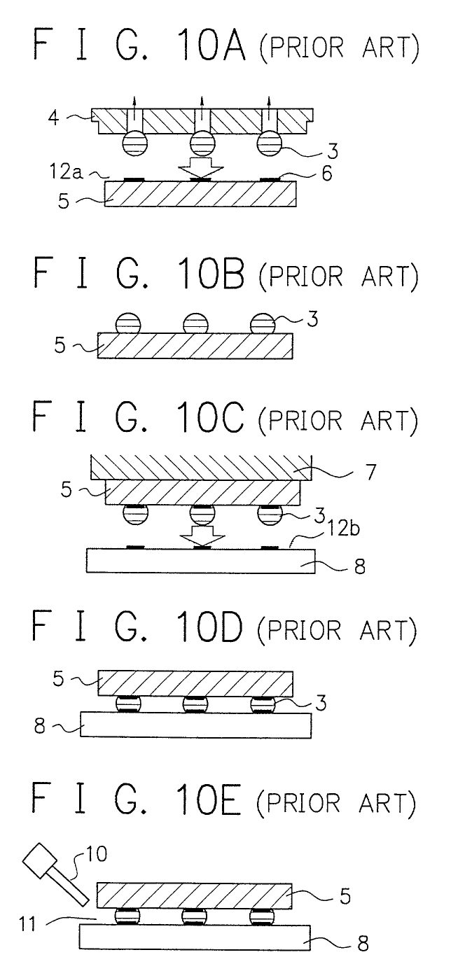

With respect to the underfill resin, any well-known resin can be used for assuring reliability. As shown in FIG. 8, the active resin 1 may also be employed as an underfill resin.

Third Embodiment:

In the methods according to the first and second embodiments, a flip chip is fabricated by using an active resin instead of a flux, thoroughly from a bump forming process to a process of mounting an LSI chip on a wiring board. In this case, an active resin used for forming the bumps may be different from that used for mounting the flip chip. For example, in a case where solder bumps made of an Sn/Pb solder having a high-melting point and rich in Pb are formed, and connection to the wiring board is made by using an Sn/Pb eutectic solder, active resins may be appropriately selected as follows. That is, an active resin used for forming bumps may be a resin with a heat resistance and cured at a high temperature, while an active resin for connection may be a resin which hardens at a relatively low temperature.

It is also possible that the active resin is applied to the overall surface of the LSI chip and cured after bumps are formed. The LSI chip thus has solder bumps including the cured active resin acting as a surface protective film.

Bare chips or LSI chips in a state similar to the bare chips are easily damaged, including a case where a re-wiring layer is formed to arrange solder bumps in a lattice. To overcome this problem, LSI chips with a protective film may be used as shown in FIG. 7, so as to prevent absent of chip or the like when the LSI chips are being handled.

The present embodiment may be applied to a wafer-level chip-size package (CSP). That is, it is possible that a solder layer is formed by using a plating or evaporation on an LSI wafer on which circuits have been built, and then an active resin is applied to the solder layer. When the solder is heated and melts, the solder becomes spherical. At the same time, the active resin is cured to form a surface protective film. Finally, a chip-size package is produced by dicing the wafer.

A method similar to the bump forming method as mentioned above may be employed for connecting solder balls which are used for external terminals of a semiconductor package of ball-grid array type. The present invention prevents, after the chip is mounted on a printed wiring board, cracks from developing in a base region of the soldered section by a thermal stress. The method is particularly effective for a chip-size package or the like with a very fine pin spacing.

According to the present invention, by the use of an active resin having the effect of flux, instead of a flux agent, a washing process for washing out the flux can be eliminated. This simplifies the overall process of soldering and advantageously lowers cost for facilities and a package assembling.

The present invention realizes highly reliable chips, because no residuary flux exists on the chips, which is a leading cause to lower a long-term reliability of the products. The active resin acts as a resin for reinforcement or a protective resin, therefore the trouble can be avoided when the chips are being handled or mounted. Particularly, a bump forming process can be appropriately carried out.

Moreover, in a flip-chip mounting process according to the present invention, a resin is filled in at a later time, which requires no exact control of quantity of the resin. In the present invention, an active resin is filled in by the use of a capillary phenomenon, therefore there is no possibility of occurrence of voids which will be caused by air introduced to the resin during the mounting operation is conducted. This results in a satisfactory yield rate regarding the mounting operation. Underfill agent can be selected accordingly to its end, therefore a resin with a high reliability can be selected as an underfill resin. Furthermore, an active resin may be employed as an underfill agent.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A method of forming solder bumps, comprising the steps of:
mounting a solder on electrodes of an LSI chip over an active resin; and
applying a heat to melt said solder, so as to form solder bumps, whereby said solder bumps are connected to said electrodes.

2. A method of forming solder bumps according to claim 1, wherein said active resin is a heat-curable resin that is cured when the heat is applied.

3. A method of forming solder bumps according to claim 1, wherein said active resin is composed of an agent having the effect of flux and a thermosetting resin.

4. A method of forming solder bumps, comprising the steps of:
mounting a solder on electrodes of an LSI chip over an active resin; and
applying a heat to melt said solder, so as to form solder bumps, whereby said solder bumps are connected to said electrodes,
wherein in said heat applying step, said solder having a predetermined shape and said electrodes are connected by substantially removing said active resin at least in the boundaries between said solder and said electrodes.

5. A method of forming solder bumps according to claim 4, wherein said active resin is a heat-curable resin that is cured when the heat is applied.

6. A method of forming solder bumps according to claim 4, wherein said active resin is composed of an agent having the effect of flux and a thermosetting resin.

7. A method of forming solder bumps, comprising the steps of
mounting a solder on electrodes of an LSI chip over an active resin; and
applying a heat to melt said solder, so as to form solder bumps, whereby said solder bumps are connected to said electrodes,
wherein in said heat applying step, said solder having a predetermined shape and said electrodes are connected by substantially removing said active resin at least in the boundaries between said solder and said electrodes,
and wherein said active resin is a heat-curable resin that is cured when the heat is applied.

8. A method of forming solder bumps according to claim 7, wherein said active resin is composed of an agent having the effect of flux and a thermosetting resin.

9. A method of mounting flip chips, comprising the steps of:
applying a first active resin to a solder with a predetermined shape and/or at least to pads of an LSI chip on which bumps are to be formed;
mounting said solder on said LSI chip so that said chip is subjected to a reflow process to form solder bumps thereupon;
applying a second active resin to end portions of said solder bumps and/or at least to pads of a board on which bumps are to be formed;
mounting said LSI chip on said board by fitting position of said chip;
applying a heat to melt said solder bumps, so that said solder bumps are being connected to said board; and
filling an underfill resin in a gap between said LSI chip and said board.

10. A method of mounting flip chips according to claim 9, wherein said first and second active resins are a thermosetting resin having the effect of flux.

11. A method of mounting flip chips according to claim 9, wherein said solder is a solder ball.

12. A mounting structure comprising:
an LSI chip that is subjected to a flip-chip mounting by using solder bumps,
characterized in that said LSI chip uses an active resin at least in connecting portions of said solder bumps and in its vicinity.

13. A mounting structure comprising:
an LSI chip having solder bumps thereupon, characterized in that a protective film composed of a cured active resin is formed on a surface of said LSI chip.

14. A mounting structure according to claim 13, wherein said mounting structure is a chip-size package.

15. A mounting structure comprising:
an LSI package to which solder balls are connected;
characterized in that connecting portions of said solder balls and in its vicinity associated with pads for external terminals of said LSI package have a resin for reinforcement composed of at least a cured active resin.

16. A mounting structure comprising:
an LSI chip and a board connected each other via solder bumps;
characterized in that a thermosetting resin having the effect of flux is cured on overall surface of said board or on portions connecting said board and said solder bumps, and in that an underfill resin is filled in a gap between said LSI chip and said board.

17. A mounting structure comprising:
an LSI chip and a board connected each other via solder bumps;
characterized in that a thermosetting resin is cured on overall surface of said LSI chip or on portions connecting said said LSI chip and said solder bumps, and on overall surface of said board or on portions connecting said board and said solder bumps, and in that an underfill resin is filled in a gap between said LSI chip and said board.
